(19) United States
(12) Patent Application Publication
(10) Pub. No.: US 2019/0308288 A1
(43) Pub. Date: Oct. 10, 2019

(54) STRAIGHT EDGE CLAMPING DEVICE WITH AN IMPROVED SLIDER

(71) Applicant: Eugene Edward EMERSON, Chehalis, WA (US)

(72) Inventor: Eugene Edward EMERSON, Chehalis, WA (US)

(21) Appl. No.: 15/947,709

(22) Filed: Apr. 6, 2018

(51) Int. Cl. B23Q 3/00; F16B 2/12

(52) U.S. Cl. CPC B23Q 3/002; F16B 2/185; F16B 2/12

(57) ABSTRACT

A straight edge clamping device for clamping workpieces includes an elongated hollow base, and first and second stops. The first stop is fixed at the base, and the second stop is movably provided along the base. The second stop has a body movably received in the channel of the base and a slider that slides in the channel and along the lower wall of the base, contacts the workpiece, and engages with the body in a locking state and disengages from the body in a releasing state. The body has a sliding portion and pressing bumps, and the slider has pressing portions having outer surfaces and inner surfaces. In the locking state the pressing bumps contact with and push the inner surfaces of the pressing portions outwards, so that the outer surfaces of the pair of pressing portions are pushed outwards and contact sidewalls of the recess tightly.

### BACKGROUND OF THE INVENTION

The present invention relates to a straight edge clamping device. More particularly, the invention relates to a straight edge clamping device used to secure workpieces and to guide a power tool along the straight edge.

Conventional straight edge clamping devices had some complicated engagements among component parts, and therefore it was not easy to have the component parts manufactured with enough precisions, to be assembled without any further adjustment or calibrating treatment of the component parts.

As a result, the conventional straight edge clamping devices were not easy to manufacture and assemble, and the assembling time and cost were high.

Accordingly, a need for a straight edge clamping device has been present for a long time considering the expansive demands in the everyday life. This invention is directed to solve these problems and satisfy the long-felt need.

### SUMMARY OF THE INVENTION

The present invention is contrived to overcome the conventional disadvantages. Therefore, an object of the invention is to provide a straight edge clamping device, which has improved structure to be manufactured and assembled without further adjustment.

An aspect of the invention provide a straight edge clamping device for clamping workpieces, comprising an elongated hollow base, a first stop, and a second stop.

The elongated hollow base has a constant cross-section, and the base has a first end, a second end, a flat lower wall for contacting workpieces, an upper wall, and two sidewalls connecting the lower wall and the upper wall.

The first stop is fixed at the first end of the base, and the second stop is movably provided along the base, so as to form a clamp for holding the workpieces together with the first stop.

The lower wall of the base has an opening, and the opening, the lower wall, the upper wall, and the sidewalls of the base define a channel.

The second stop has a body movably received in the channel of the base and a slider that slides in the channel and along the lower wall of the base, contacts the workpiece, and engages with the body in a locking state and disengages from the body in a releasing state. The body has a sliding portion, a handle, an opening, a stop extending horizontally from the sliding portion, a pair of pressing bumps, and a hole, wherein the slider has a jaw, a rail, a projection, a channel, and a pair of pressing portions having outer surfaces and inner surfaces. In the locking state the pair of pressing bumps contact with and push the inner surfaces of the pair of pressing portions outwards, so that the outer surfaces of the pair of pressing portions are pushed outwards and contact sidewalls of the recess tightly.

The body of the second stop has a shape reverse to the shape of the channel of the base so that the body and the channel interlock.

The upper wall of the base has one or more recesses. The width of each of the recesses is smaller than the distance between the two sidewalls by a predetermined distance. The body of the second stop has one or more projections having a shape reverse to the shape of the recesses so that the recesses and the projections interlock.

The base may further comprise two slant walls between the sidewalls and the upper wall.

The angle between the slant walls and the sidewalls may be approximately 45 degrees.

The first stop may have a body inserted in the channel of the base and a stop for securing the workpieces, and the body of the first stop has a shape reverse to the shape of the channel of the base so that the body and the channel interlock, and the body of the first stop has one or more projections having a shape reverse to the shape of the recesses so that the recesses and the projections interlock.

The recess of the base may be rectangular and the projection of the second stop may be rectangular.

The depth of the recess of the base may be approximately one sixteenth of an inch, and the height of the projection of the second stop may be approximately one sixteenth of an inch.

The depth of the recess of the base may be approximately one eighth of an inch, and the height of the projection of the second stop may be approximately one eighth of an inch.

The upper wall of the base may further comprise a guide channel, and the clamping device further comprises a drill guide movably provided along the base, and the drill guide may have a fastener that is guided in the guide channel of the base.

The advantages of the present invention are: (1) the straight edge clamping device according to the invention is easy to manufacture; (2) the straight edge clamping device according to the invention is easy to assemble without any further adjusting machining; and (3) the straight edge clamping device according to the invention facilitate the clamping function.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a front elevational view of a straight edge clamping device according to an embodiment of the present invention;

FIG. 2 is a cross-sectional view taken along 2-2 in FIG. 1;

FIG. 3 is a bottom plan view of the jig;

FIG. 4 is a cross-sectional view taken along 4-4 in FIG. 1;

FIG. 5 is an elevational view of a first stop;

FIG. 6 is a cross-sectional view of a second stop taken along 6-6 in FIG. 1;

FIG. 7 is a plan view of a body of the second stop;

FIG. 8 is an elevational view of the body of the second stop;

FIG. 9 is a left side elevational view of the body of the second stop;

FIG. 10 is a right side elevational view of the body of the second stop;

FIG. 11 is a plan view of a slider of the second stop;

FIG. 12 is a front elevational view of the slider of the second stop;

FIG. 13 is a bottom plan view of the slider of the second stop;

FIG. 14 is a right side elevational view of the slider of the second stop;

FIG. 15 is a left side elevational view of the slider of the second stop;

FIG. 16 is a side elevational view of a locking element of the second stop;

FIG. 17 is a front elevational view of the locking element of the second stop;

FIG. 18 is an elevational view showing a released state of the second stop;

FIG. 19 is an elevational view showing a locked state of the second stop;

FIG. 20 is a plan view of an end cap;

FIG. 21 is an elevational view of the end cap;

FIG. 22 is a perspective view of a straight edge clamping device according to an embodiment of the invention;

FIG. 23 is a plan view showing an inner side of a second stop according to an embodiment of the invention;

FIG. 24 is a perspective view showing the second stop of FIG. 23;

FIG. 25 is another perspective view showing the second stop of FIG. 23 with a slider disassembled;

FIG. 26 is another plan view of the second stop of FIG. 25 with the slider disassembled completely;

FIG. 27 is a perspective view of the slider in FIG. 26;

FIG. 28 is another perspective view of the slider in FIG. 26;

FIG. 29 is a perspective and cross-sectional view of an elongated hollow base in FIG. 23 according to an embodiment of the invention;

FIG. 30 is a perspective view showing the second stop to be disposed at an edge of FIG. 22;

FIG. 31 is a plan view of a body of the second stop as a variation of FIG. 7 according to another embodiment of the invention;

FIG. 32 is an elevational view of the body of the second stop as a variation of FIG. 8 according to another embodiment of the invention;

FIG. 33 is a perspective view showing the second stop as a variation of FIG. 24 according to another embodiment of the invention;

FIG. 34 is another perspective view showing the second stop with a slider disassembled as a variation of FIG. 25 according to another embodiment of the invention; and

FIG. 35 is another plan view of the second stop with the slider disassembled completely as a variation of FIG. 26 according to another embodiment of the invention.

### DETAILED DESCRIPTION OF THE PREFERRED EMBODIMENTS

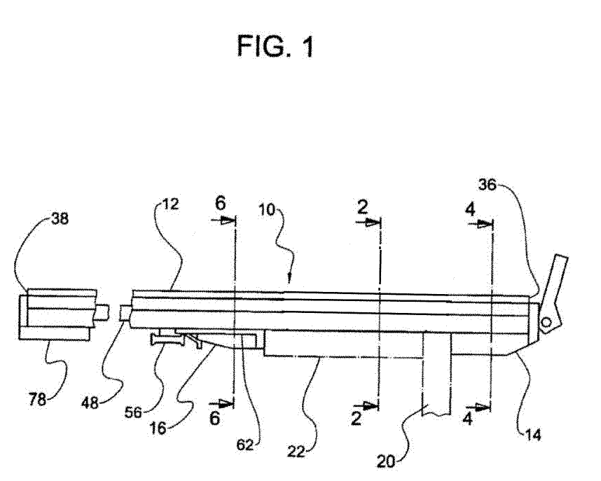

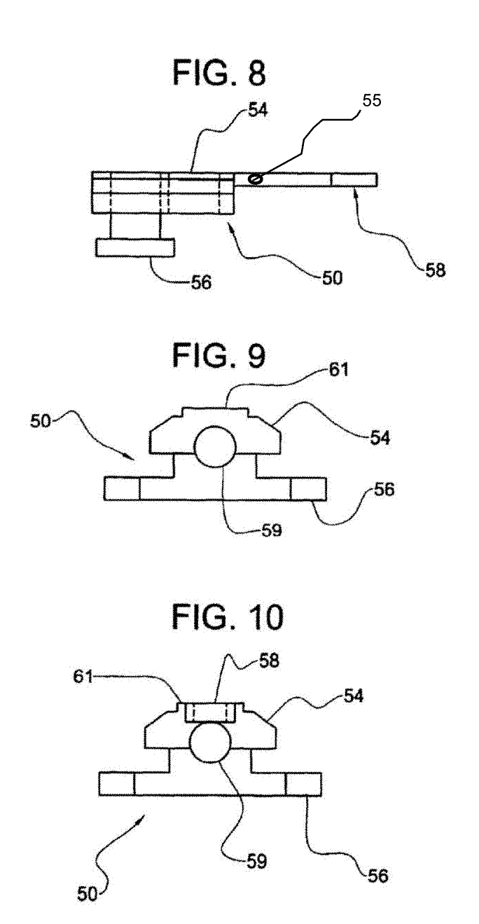

FIGS. 1-21 show a straight edge clamping device 10 according to the first embodiment of the present invention. The device 10 may also be used as a straight edge clamping device for woodworking.

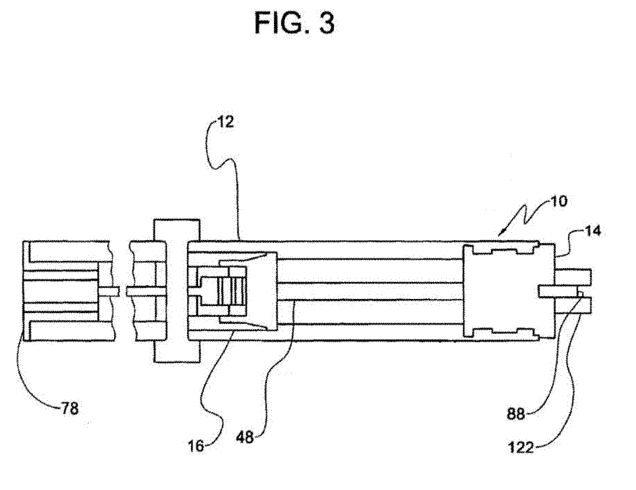

As shown in FIGS. 1 and 3, the straight edge clamping device 10 includes a bar-shaped base or a straight edge 12, a first stop 14, a second stop 16, and a drill guide 18. FIG. 1 also shows two workpieces 20, 22 with imaginary lines.

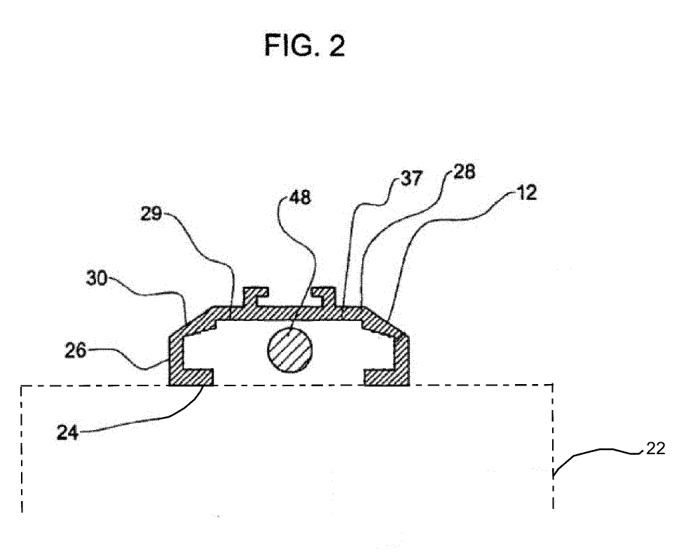

As shown in FIG. 2, the base 12 has a constant cross-section and is typically made of extruded aluminum. The cross-section of the base is defined by two lower walls 24 that form a flat surface which is flush with a surface of the workpiece 20, two sidewalls 26 that extend upward from the lower walls 24, an upper wall 28, and two slant walls 30 that connect the upper wall 28 and the sidewalls 26. The angle between the slant walls 30 and sidewalls 26 is approximately 45 degrees. An opening 32 is formed between the lower walls 24.

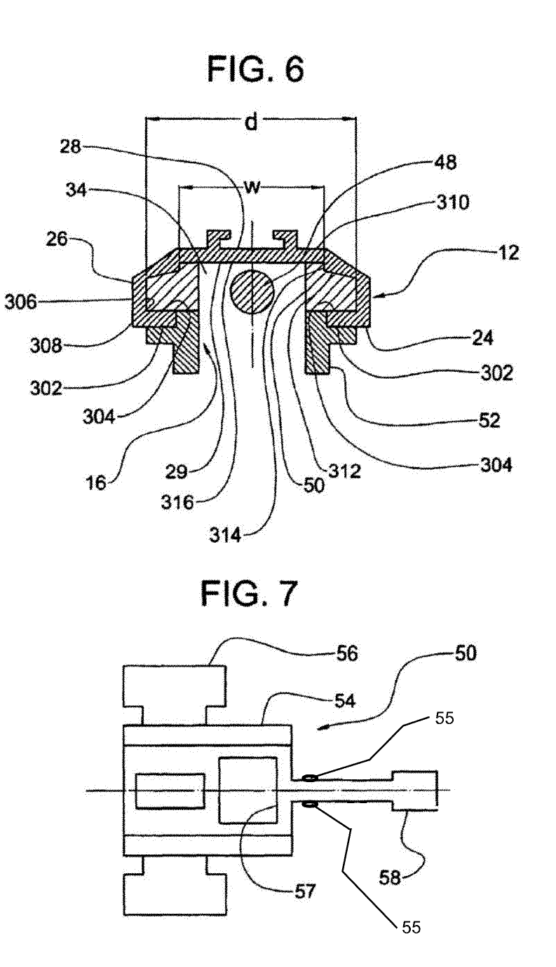

As shown in FIG. 6, the lower wall 24 has an outer-lower wall 302 and an inner-lower wall 304. The sidewall 26 has an outer-side wall 306 and an inner-side wall 308. The upper wall 28 has an outer-upper wall 310 and an inner-upper wall 312. The inner-upper wall 312 has a recess 29. The recess 29 has two vertical-inner-upper wall 314 and a horizontal-inner-upper wall 316.

The inner-lower walls 304, the inner-side walls 308, the inner-upper wall 312, and the recess 29 form an open channel 34.

The width w of the recess 29 is smaller than the distance d between the two inner-side walls 308 by a predetermined distance.

The base also has two ends 36, 38. Another and smaller open channel 23 is defined by two protrusions 25 protruding upward from the upper wall 28 and another two protrusions 27 protruding toward each other from the protrusions 25.

The recess 29 provides additional interlocking effect to elements received in the channel 34, that is, the first stop 14 and the second stop 16, etc. The recess 29 is rectangular and has a depth of approximately one sixteenth of an inch, or one eighth of an inch. The width and depth of the recess are chosen to ease the manufacturing process and to increase the interlocking ability between the base 12 and the elements received in the base. More than one recesses may provided in the upper wall 28. The recess may be provided in other walls defining the channel 34.

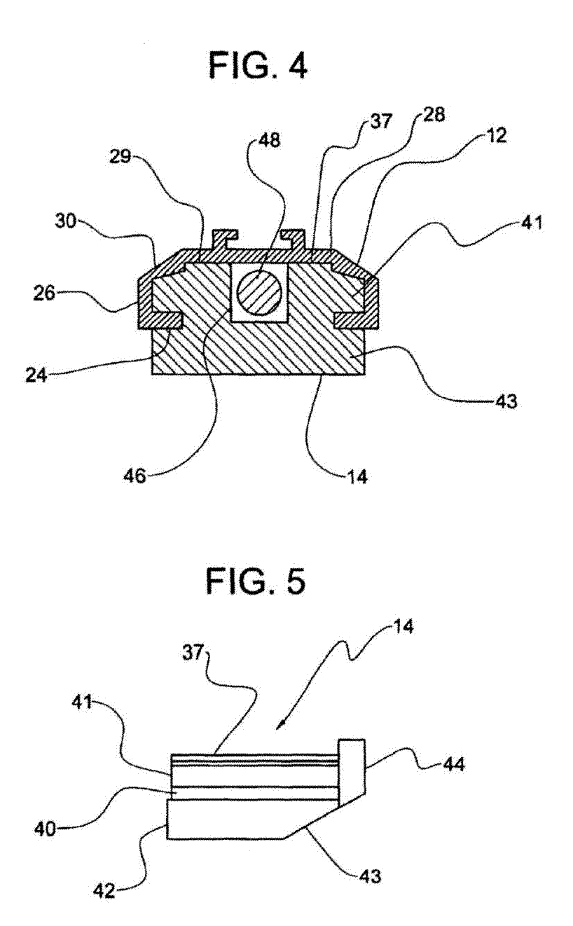

The first stop 14 is fixed to the end 36 of the base 12 and is used to secure the workpiece 20. As shown in FIGS. 4 and 5, the first stop 14 has grooves 40 in which the lower walls 24 of the base 12 fit tightly. The portion of the first stop 14 received in the channel 34 of the base 12 forms a body 41 of the first stop 14. The body 41 has a shape that is reverse to the channel 34 so that the first stop 14 and the base 12 interlock. The body 41 has a projection 37 that interlocks with the recess 29 of the base 12. The portion of the first stop 14 outside the channel 34 forms a stop 43. The stop 43 has a jaw or wall 42 that contacts the workpiece 20. The first stop 14 also has an end wall 44 that is opposite to the jaw 42 and covers the end 36 of the base 12, and a channel 46 that receives a rod 48. The rod 48 is received within the channel 34 of the base 12.

The second stop 16 is received in the channel 34 of the base 12 and movable along the base 12. The second stop 16 is used to secure the workpiece 22. As shown in FIG. 6, the second stop 16 has a body 50 that slides in the channel 34 of the base 12, and a slider 52 that slides in the channel 34 and along the lower wall 24 of the base 12 and contacts the workpiece 22.

FIGS. 7-10 show the body 50 of the second stop 16. The body 50 has a sliding portion 54, a handle 56, an opening 57, a stop 58, and a hole 59. The sliding portion 54 has a shape that is reverse to the shape of the channel 34 so that the sliding portion 54 and the channel 34 interlock. The sliding portion 54 has a projection 61 that interlocks with the recess 29 of the base 12. The projection 61 is rectangular and has a height of approximately one sixteenth of an inch, or one eighth of an inch. The opening 57 is provided in the sliding portion 54. The handle 56 is provided below the sliding portion 54 so that a worker can hold it by hand to move the second stop 16 along the base 12. The stop 58 horizontally extends from the sliding portion 54. The hole 59 is provided in the middle of the second stop 16 to receive the rod 48.

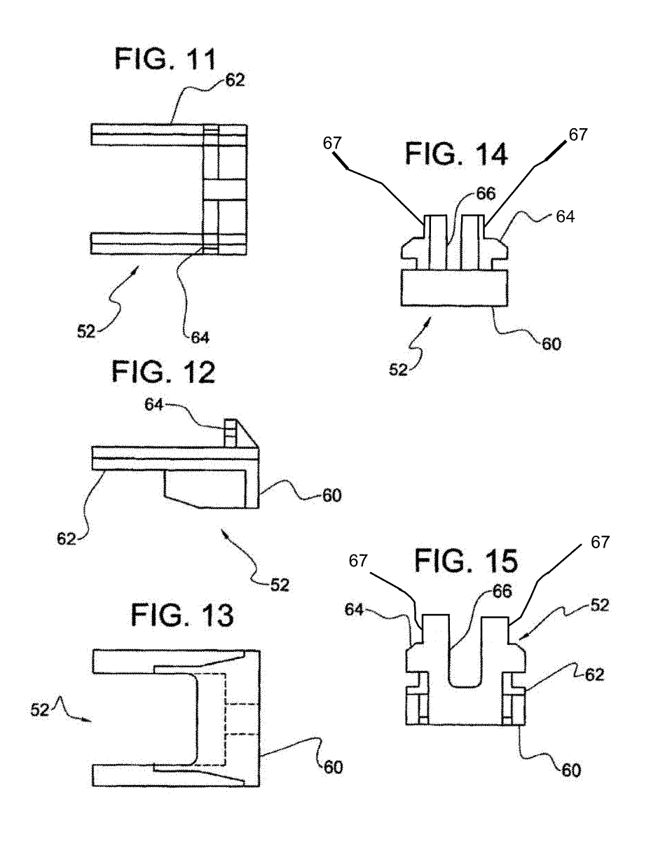

FIGS. 11-15 show the slider 52 of the second stop 16. The slider has the role of a stop securing a workpiece. The slider has a jaw 60, a rail 62, a projection 64, and a channel 66. The rail 62 slides over the lower wall 24 of the base 12. The jaw 60 is provided below the rail 62 and contacts the workpiece 22. The projection 64 is provided above the rail 62 and has a shape that is reverse to the shape of the channel 34 of the base 12 so that the projection 64 and the channel 34 interlock. The channel 66 receives the rod 48.

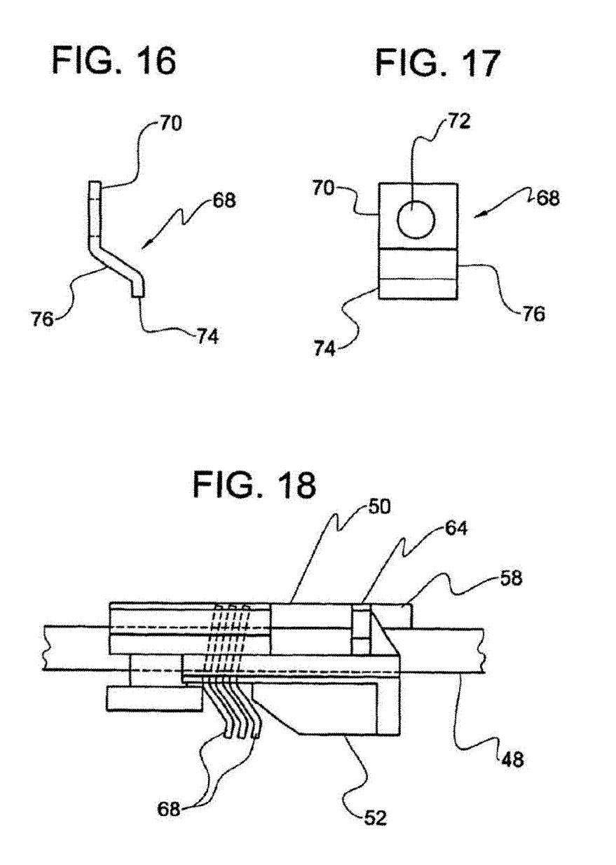

FIGS. 16 and 17 show a locking element 68. The locking element 68 has a flat portion 70, a hole 72 provided in the flat portion 70, an end 74, and a bent portion 76 that connects the flat portion 70 and the end 74.

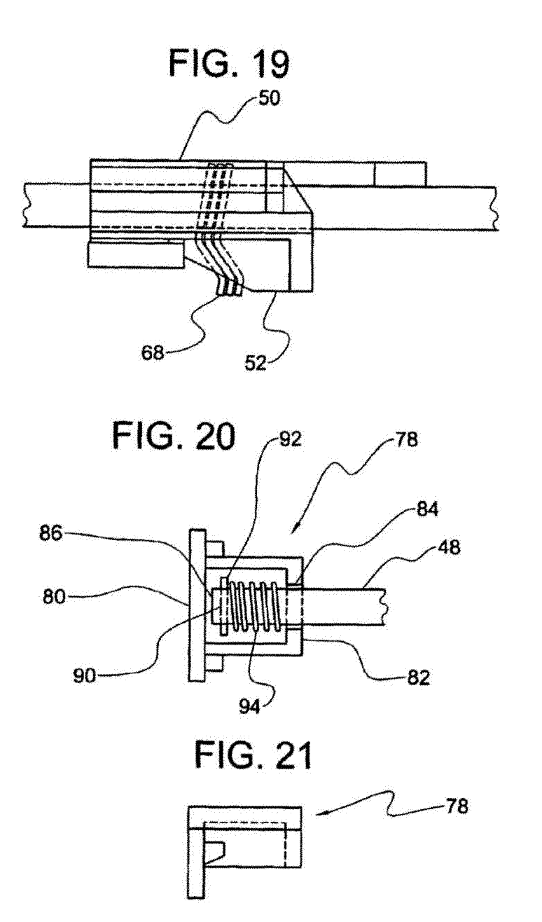

FIG. 18 shows a released state of the second stop 16. FIG. 19 shows a locked state of the second stop 16. A plurality of the locking elements 68 is positioned in the opening 57 of the second stop 16. The rod 48 passes through the hole 59 of the second stop 16 and the holes 72 of the locking elements 68. In the released state, the body 50 is away from the slider 52 so that there are spaces between the locking elements 68 and thus, the locking elements 68 are loose from each other and from the rod 48. The second stop 16 can move along the rod 48 freely. The body's away movement is stopped when the projection 64 of the slider contacts the stop 58 of the body 50. In the locked state, the body 50 moves toward the slider 52 and the locking elements 68 are tightened between the body 50 and the slider 52 so that there are no gaps between the locking elements 68. Thus, in the locked state, the slider 52 moves integrally with the body 50.

In the locked state, the second stop 16 can move toward the first stop since the body 50 pushes the locking elements 68 near the center of the rod 48 and the pushing force is applied uniformly around the hole 72, and the locking elements 68 can slide along the rod 48. However, moving in reverse direction is blocked since the slider 52 pushes the ends 74 of the locking element 48 and the pushing force is applied at a point offset from the center of the holes 72 and the rod 48, thereby locking the holes 72 on the rod 48.

FIGS. 20 and 21 show an end cap 78 that is fixed at the end 38 of the base 12. The end cap 78 has a wall 80 that covers the end 38, and a wall 82 that is opposite to the wall 80. The wall 82 has a channel 84 that receives the rod 48. The rod 48 has two ends 86, 88. A hole 90 is provided at the end 86 of the rod 48. A pin 92 is inserted into the hole 90 forming a stop. A spring 94 surrounds the rod 48 between the pin 92 and the wall 82 of the end cap 78 so that displacement of the spring 94 is confined between the pin 92 and the wall 82.

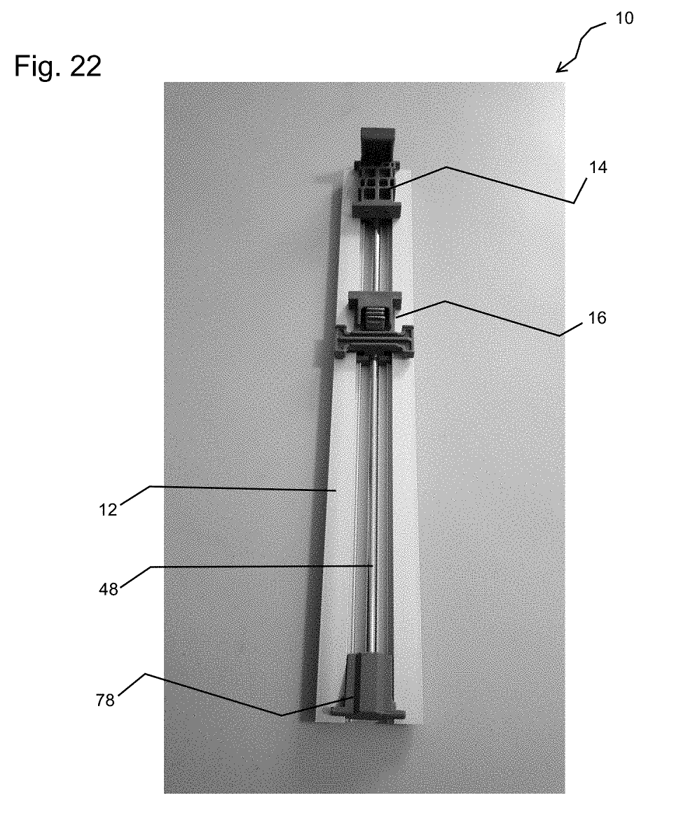

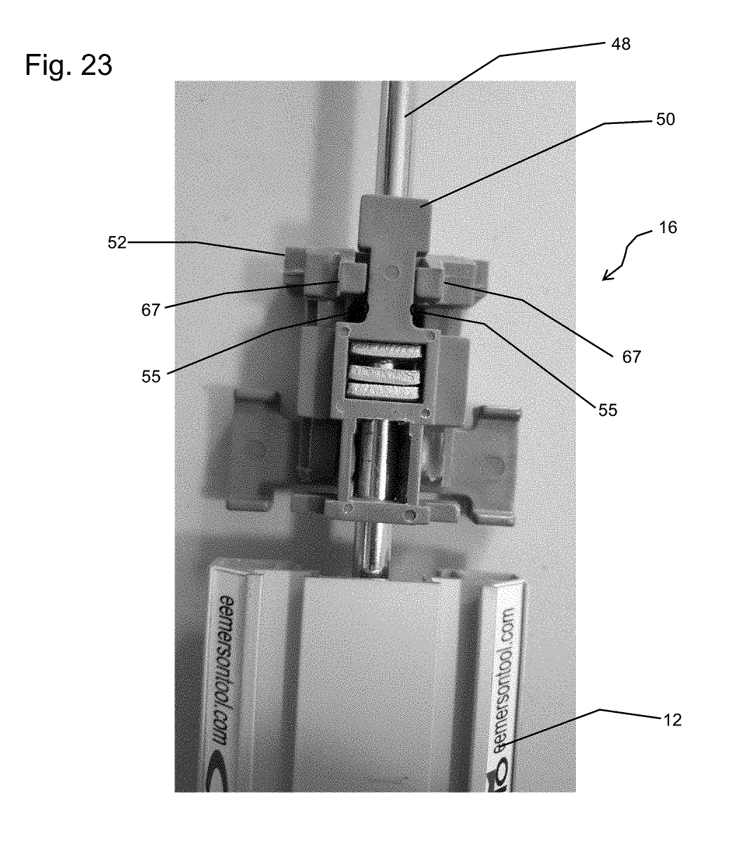

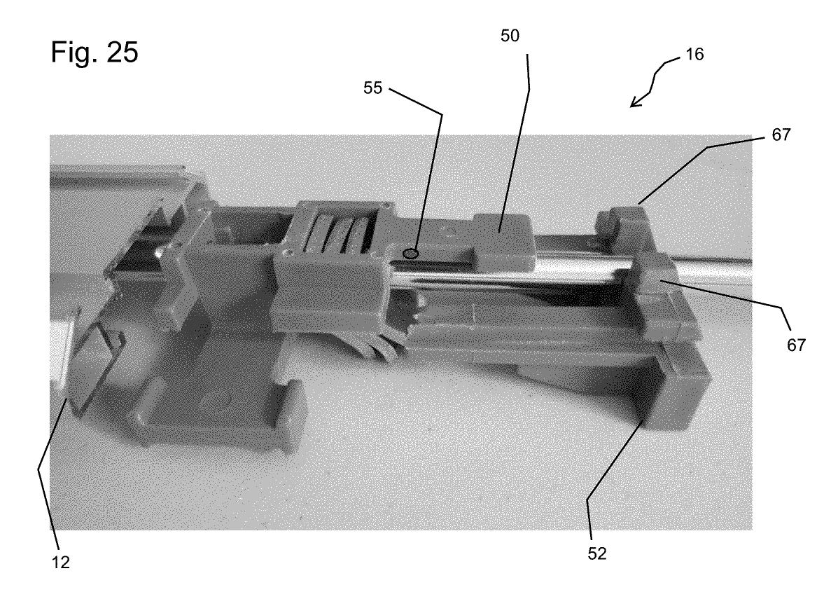

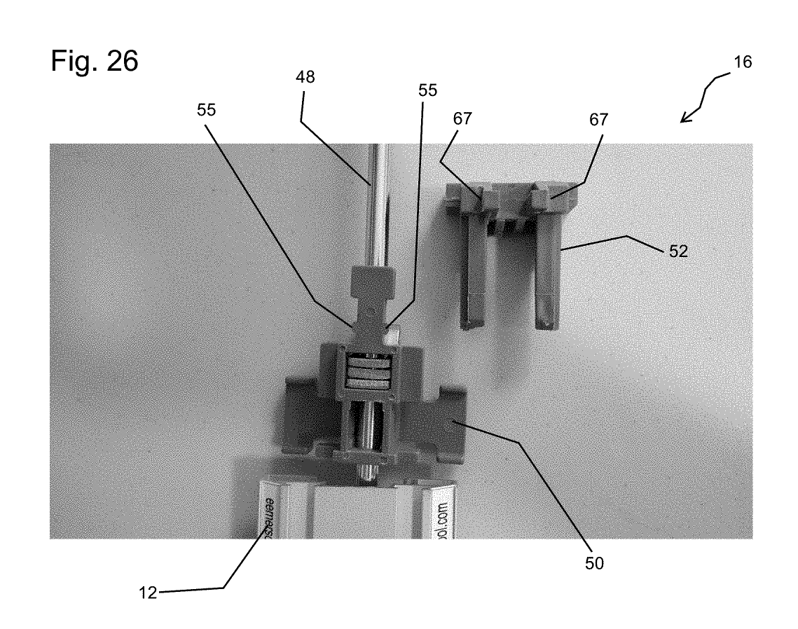

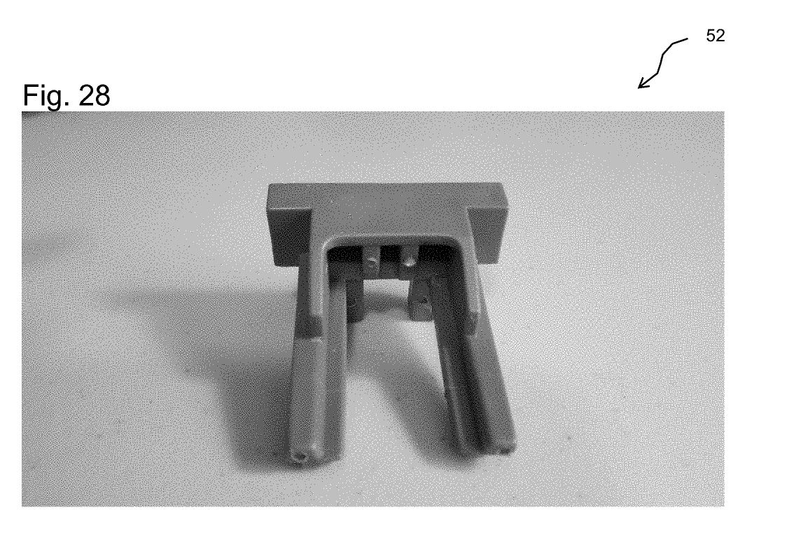

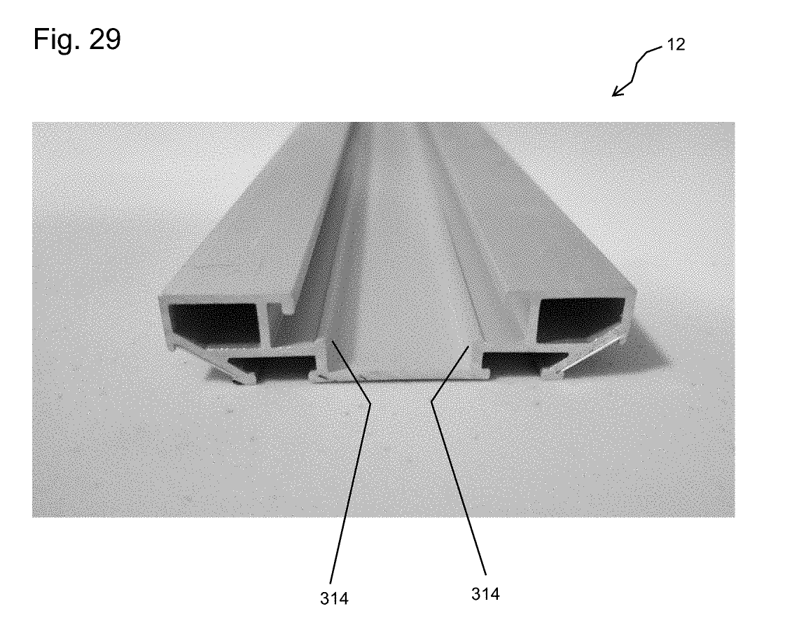

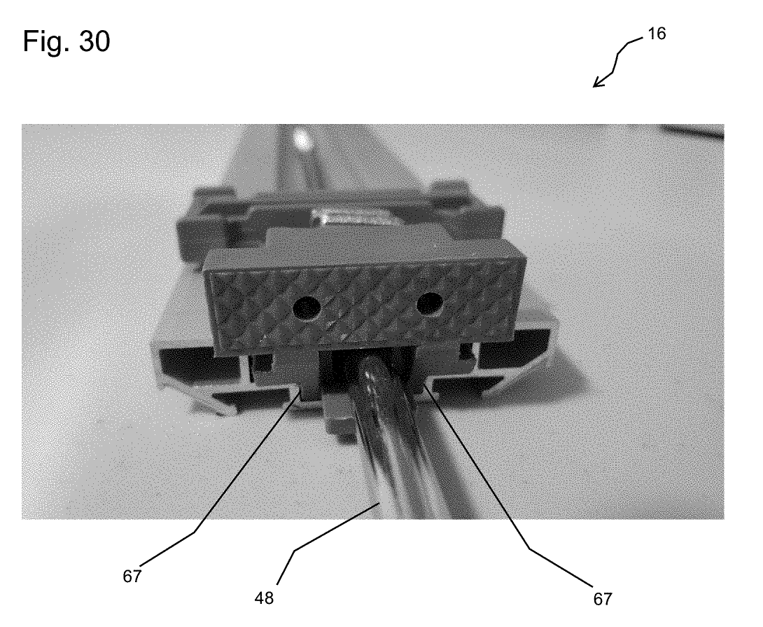

FIGS. 22-30 show a straight edge clamping device 10 according to another embodiment of the invention. The same reference numerals are used for the same parts and components as in FIGS. 1-21.

An aspect of the invention provide the straight edge clamping device 10 for clamping workpieces, comprising an elongated hollow base 12, a first stop 14, and a second stop 16.

The elongated hollow base 12 has a constant cross-section, and the base 12 has a first end, a second end, a flat lower wall for contacting workpieces, an upper wall, and two sidewalls connecting the lower wall and the upper wall.

The first stop 14 is fixed at the first end of the base, and the second stop 16 is movably provided along the base 12, so as to form a clamp for holding the workpieces together with the first stop 14.

The lower wall 24 of the base 12 has an opening 32, and the opening 32, the lower wall 24, the upper wall 28, and the sidewalls 26 of the base define a channel (34).

As shown in FIGS. 7-8, 14-15, and 23-27, the second stop 16 has a body 50 movably received in the channel 34 of the base 12 and a slider 52 that slides in the channel 34 and along the lower wall 24 of the base 12, contacts the workpiece 22, and engages with the body 50 in a locking state and disengages from the body 50 in a releasing state. The body 50 has a sliding portion 54, a handle 56, an opening 57, a stop 58 extending horizontally from the sliding portion 54, a pair of pressing members or pressing bumps 55, and a hole 59, wherein the slider 52 has a jaw 60, a rail 62, a projection 64, a channel 66, and a pair of pressing portions 67 having outer surfaces and inner surfaces. In the locking state the pair of pressing members or pressing bumps 55 contact with and push the inner surfaces of the pair of pressing portions 67 outwards, so that the outer surfaces of the pair of pressing portions 67 are pushed outwards and contact sidewalls 314 of the recess 29 tightly.

The body 50 of the second stop 16 has a shape reverse to the shape of the channel 34 of the base 12 so that the body 50 and the channel 34 interlock.

The upper wall 28 of the base 12 has one or more recesses 29. The width of each of the recesses 29 is smaller than the distance between the two sidewalls 26 by a predetermined distance. The body 50 of the second stop 16 has one or more projections 61 having a shape reverse to the shape of the recesses 29 so that the recesses 29 and the projections 61 interlock.

The base 12 may further comprise two slant walls 30 between the sidewalls 26 and the upper wall 28.

The angle between the slant walls 30 and the sidewalls 26 may be approximately 45 degrees.

The first stop 14 may have a body inserted in the channel of the base and a stop for securing the workpieces, and the body of the first stop 14 has a shape reverse to the shape of the channel of the base so that the body and the channel interlock, and the body of the first stop 14 has one or more projections having a shape reverse to the shape of the recesses so that the recesses and the projections interlock.

The recess of the base 12 may be rectangular and the projection 61 of the second stop 16 may be rectangular.

The depth of the recess of the base may be approximately one sixteenth of an inch, and the height of the projection of the second stop 16 may be approximately one sixteenth of an inch.

The depth of the recess of the base may be approximately one eighth of an inch, and the height of the projection of the second stop 16 may be approximately one eighth of an inch.

The upper wall of the base may further comprise a guide channel, and the clamping device further comprises a drill guide movably provided along the base, and the drill guide may have a fastener that is guided in the guide channel of the base.

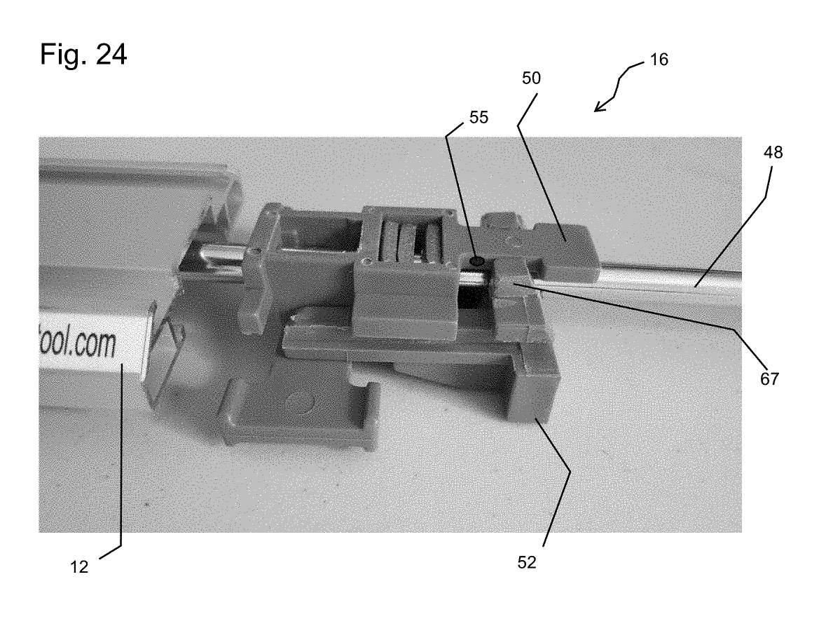

As illustrated in FIGS. 7-8, 14-15, and 23-27, the pair of pressing members or pressing bumps 55 are provided where the slider 52 is in a locking position. For example, in FIG. 24, the slider 52 is in a released position. In order to get in a locking state, the slider 52 is pushed to the left so that the inner side behind the pressing portion 67 is mounted on the pressing bump 55.

The exact position can be adjusted based on the relative dimension of the body 50 and the slider 52. The shape and size of each of the pair of pressing members or pressing bumps 55 can be chosen so as to make it sure to lock and push outwards the pair of pressing portions 67. Thanks to the presence of the pair of pressing members or pressing bumps 55, the pair of pressing portions 67 can manufactured easily with some margin, which can be accommodated by being pushed outwards. Preferably, each of the pair of pressing members or pressing bumps 55 can have a shape of hemisphere, pyramid, or just a cube.

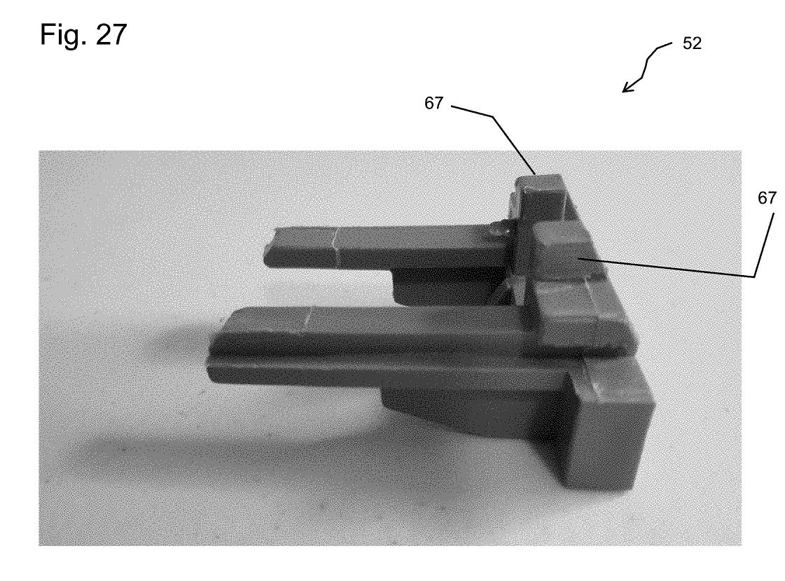

In prior arts, the surface corresponding to the portion 67 (refer to FIG. 27) must be machined exactly with respect to the vertical-inner-upper wall 314. In contrast, in the present invention, such additional adjustment or milling is simply unnecessary.

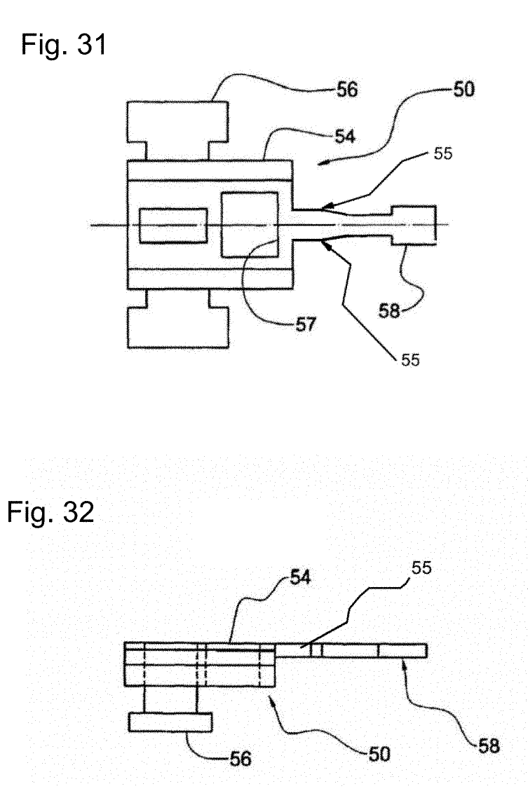

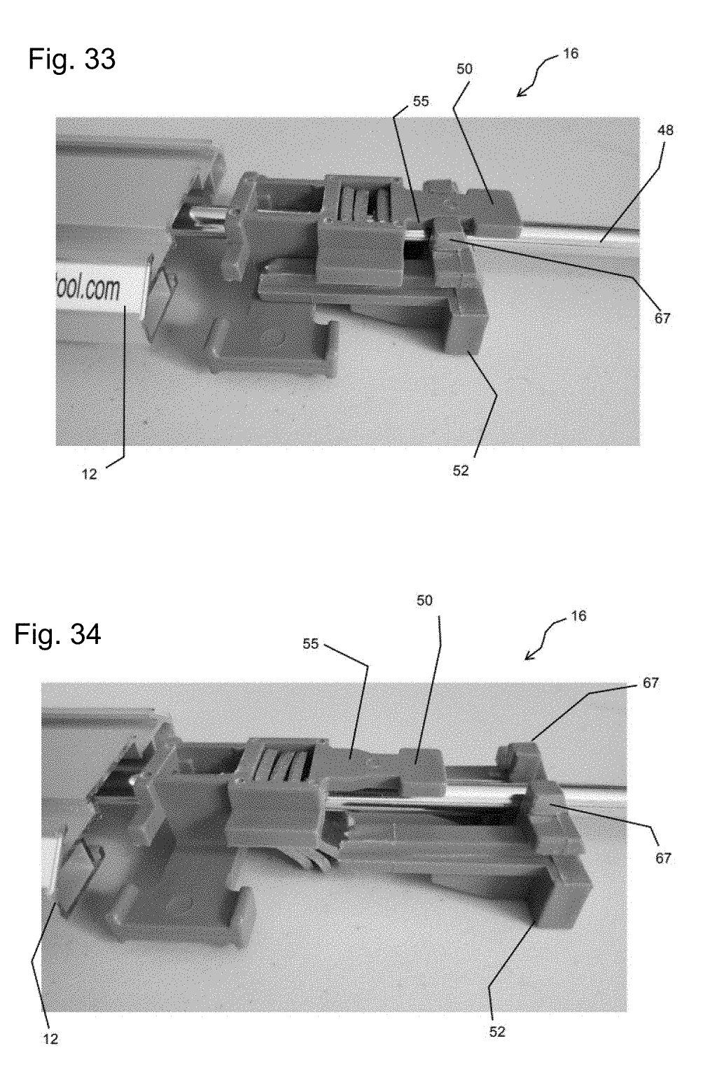

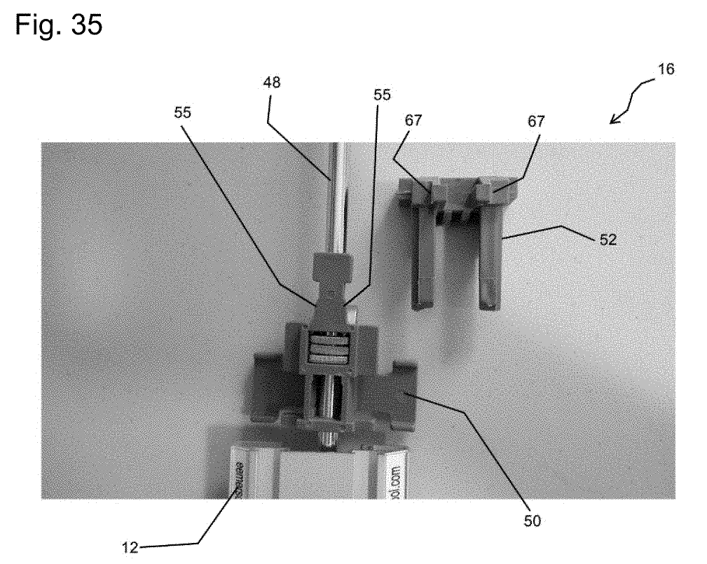

In certain embodiments of the invention, the pair of pressing members or pressing bumps 55 may be provided in the form of widening of corresponding portions, as shown in FIGS. 31 through 35.

That is, the pair of pressing members 55 may comprise a pair of pressing bumps as shown in FIGS. 7, 8, and 24-26.

Alternatively, the pair of pressing members 55 may comprise a pair of pressing tilted surfaces as shown in FIGS. 31-35. The pair of pressing tilted surfaces are provided on both sides of the body 50 in a form of triangular wings, when comparing FIG. 7 with FIG. 31. Along the length portion of the body 50, the width may be widened linearly to a certain point, which may correspond to the position of the pressing bumps in FIG. 7.

Although the invention has been described in considerable detail, other versions are possible by converting the aforementioned construction. Therefore, the scope of the invention shall not be limited by the specification specified above and the appended claims.

What is claimed is:

1. A straight edge clamping device for clamping workpieces comprising:
an elongated hollow base having a constant cross-section,
the base having a first end, a second end, a flat lower wall for contacting workpieces, an upper wall, and two sidewalls connecting the lower wall and the upper wall;
a first stop fixed at the first end of the base; and
a second stop movably provided along the base, so as to form a clamp for holding the workpieces together with the first stop,
wherein the lower wall of the base has an opening, and the opening, the lower wall, the upper wall, and the sidewalls of the base define a channel,
wherein the second stop has a body movably received in the channel of the base and a slider that slides in the channel and along the lower wall of the base, contacts the workpiece, and engages with the body in a locking state and disengages from the body in a releasing state, wherein the body has a sliding portion, a handle, an opening, a stop extending horizontally from the sliding portion, a pair of pressing members, and a hole, wherein the slider has a jaw, a rail, a projection, a channel, and a pair of pressing portions having outer surfaces and inner surfaces, wherein in the locking state the pair of pressing members contact with and push the inner surfaces of the pair of pressing portions outwards, so that the outer surfaces of the pair of pressing portions are pushed outwards and contact sidewalls of the recess tightly,
wherein the body of the second stop has a shape reverse to the shape of the channel of the base so that the body and the channel interlock,
wherein the upper wall of the base has one or more recesses, wherein the width of each of the recesses is smaller than the distance between the two sidewalls by a predetermined distance, and wherein the body of the second stop has one or more projections having a shape reverse to the shape of the recesses so that the recesses and the projections interlock.

2. A straight edge clamping device of claim 1 wherein the base further comprises two slant walls between the sidewalls and the upper wall.

3. A straight edge clamping device of claim 1 wherein the angle between the slant walls and the sidewalls is approximately 45 degrees.

4. A straight edge clamping device of claim 1 wherein the first stop has a body inserted in the channel of the base and a stop for securing the workpieces, wherein the body of the first stop has a shape reverse to the shape of the channel of the base so that the body and the channel interlock, and wherein the body of the first stop has one or more projections having a shape reverse to the shape of the recesses so that the recesses and the projections interlock.

5. A straight edge clamping device of claim 1 wherein the recess of the base is rectangular and the projection of the second stop is rectangular.

6. A straight edge clamping device of claim 5 wherein the depth of the recess of the base is approximately one sixteenth of an inch, and wherein the height of the projection of the second stop is approximately one sixteenth of an inch.

7. A straight edge clamping device of claim 5 wherein the depth of the recess of the base is approximately one eighth of an inch, and wherein the height of the projection of the second stop is approximately one eighth of an inch.

8. A straight edge clamping device of claim 1 wherein the upper wall of the base further comprises a guide channel, and the clamping device further comprises a drill guide movably provided along the base, and wherein the drill guide has a fastener that is guided in the guide channel of the base.

9. A straight edge clamping device of claim 1 wherein the pair of pressing members comprise a pair of pressing bumps.

10. A straight edge clamping device of claim 1 wherein the pair of pressing members comprise a pair of pressing tilted surfaces.
